(19) United States
(12) Patent Application Publication
(10) Pub. No.: US 2006/0133374 A1
(43) Pub. Date: Jun. 22, 2006

(54) Packet exchange device and packet exchange method

(75) Inventor: Akihiko Sekiguchi, Tokyo (JP)

Correspondence Address: MICHAEL BEST & FRIEDRICH LLP, Two Prudential Plaza, 180 North Stetson Avenue, Suite 2000, CHICAGO, IL, 60601, US

(73) Assignee: NEC Corporation, Tokyo (JP)

(21) Appl. No.: 11/315,871

(22) Filed: Dec. 22, 2005

(30) Foreign Application Priority Data
Dec. 22, 2004 (JP) 2004-370702

(51) Int. Cl. H04L 12/56; H04L 12/28

(52) U.S. Cl. 370/389

(57) ABSTRACT

Registered in a table are an output port number and a MAC address so as to correlate with transmission source and transmission destination IP addresses of a packet. When no information of a flow to which a received packet belongs is registered at the table, a first path unit transfers the packet to a middle path unit. When the packet from the first path unit is a packet to be a target of exception processing, the middle path unit transfers the packet to a slow path unit to cause the same to execute exception processing and otherwise, searches a routing table to obtain an output port number and a MAC address and outputs the packet to a relevant IF unit. The slow path unit registers the output port number and the MAC address obtained by the middle path unit and the transmission source and transmission destination IP addresses of the packet at the table.

### BACKGROUND OF THE INVENTION

1. Field of the Invention

The present invention relates to a packet exchange device such as a router or a multi-layer switch, and more particularly, a packet transfer processing speed-up technique.

2. Description of the Related Art

In packet communication networks such as the Internet, data is transferred on a packet basis. With a header part including a transmission source IP address and a transmission destination IP address attached to a packet, a packet exchange device transfers the packet to an appropriate network based on the address information of the header part.

One example of such conventional packet exchange devices is disclosed in Japanese Patent Laying-Open No. 2000-295274.

With reference to FIG. 8, the packet exchange device disclosed in Japanese Patent Laying-Open No. 2000-295274 includes a microprocessor 110, a main memory 120, a processor bus 130 which connects the microprocessor 110 and the main memory 120 or other peripheral processing unit, a packet processing unit 140 which executes packet processing in place of the microprocessor 110, a packet memory 150, a search processing unit 160 and an IP flow table 170, a security processing unit 190 which executes encipherment/encoding processing of the packet, a lower-order layer processing unit 200, and a switch fabric 180 which connects the packet processing unit 140, the security processing unit 190 and the lower-order layer processing unit 200.

Conventional packet exchange-device having such a structure as described above operates in the following manner.

Upon receiving a packet, the packet processing unit 140 transfers a transmission source IP address and a transmission destination IP address set at its header part to the search processing unit 160.

The search processing unit 160 searches the IP flow table 170 with the transmission source IP address and the transmission destination IP address transferred from the packet processing unit 140 as a key. Registered in the IP flow table 170 are an output port number, a MAC address of a subsequent hop and the like so as to correlate with a transmission source IP address and a transmission destination IP address.

Then, when a relevant entry is searched out, return an output port number and a MAC address stored in the entry to the packet processing unit 140.

On the other hand, when the relevant entry is not searched out, based on an instruction from the packet processing unit 140 having received a search failure notification, temporarily register a new entry at the IP flow table 170 with the transmission source IP address and the transmission destination IP address transferred from the packet processing unit 140 as a key.

When an output port number and a MAC address are returned from the search processing unit 160, the packet processing unit 140 executes header processing of attaching a MAC header including the above MAC address to a received packet and then outputs the packet to an interface unit specified by the above output port number.

On the other hand, when the search by the search processing unit 160 fails, the packet processing unit 140 interrupts the microprocessor (CPU) 110.

When interrupted, the microprocessor (CPU) 110 starts routing processing to obtain an output port number and a MAC address of a subsequent hop based on a transmission source IP address and a transmission destination IP address of a packet registered in a processing waiting queue of the packet memory 150 to register the obtained output port number and MAC address at the temporarily registered entry of the IP flow table 170.

With respect to a packet registered in the processing waiting queue, the packet processing unit 140 transfers its transmission source IP address and transmission destination IP address to the search processing unit 160 during the processing and when the output port number and the MAC address are returned from the search processing unit 160, attaches the MAC header to the above packet and then outputs the packet to the interface unit corresponding to the above output port number.

According to the above-described conventional technique, as to a packet having the same transmission source IP address and transmission destination IP address of a packet whose routing processing is once executed by the CPU, routing processing by program-control using the CPU is unnecessary, so that the packet transfer processing speed can be sped up.

In the packet exchange device, executed other than the above-described packet transfer processing is exception processing including processing of an IPv4 option packet and processing of an IPv6 expansion header. Such exception processing is executed in the CPU of the packet exchange device. Accordingly, under the environment where exception processing occurs frequently, load on the CPU will be increased to lower a processing speed of the routing processing.

Thus, in a conventional packet exchange device which executes two processing of routing processing and exception processing by a CPU, when exception processing occurs frequently, a processing speed of the routing processing is decreased to invite reduction in a processing speed of packet transfer processing.

### SUMMARY OF THE INVENTION

An object of the present invention is to speed up packet transfer processing by enabling routing processing to be executed at a high speed under the environment where exception processing occurs frequently.

The packet exchange device according to the present invention, which is used in a packet communication network to execute routing processing on a packet basis, thereby transferring a packet, includes a first path unit which outputs a received packet to an output port of an output port number corresponding to a transmission source address and a transmission destination address of the packet which is registered in a flow cache table, a middle path unit which executes routing processing of determining an output port number with respect to the packet, and a slow path unit which executes exception processing with respect to the packet, in which the first path unit, when the output port number is not registered in the flow cache table, transfers the packet to the middle path unit without outputting the packet to the output port and the middle path unit, when the packet from the first path unit is not a target for exception processing, executes the routing processing and when the packet is a target for exception processing, transfers the packet to the slow path unit.

In the packet exchange device according to the present invention, at the flow cache table, an output port number for a packet obtained by the routing processing by the middle path unit and a transmission source address and a transmission destination address of the packet are registered so as to correlate with each other.

In the packet exchange device of the present invention, the first path unit includes a search processing unit which searches the flow cache table with a transmission source address and a transmission destination address of a packet as a key and a packet processing unit which, when an output port number of an output port which outputs the packet is searched out by the search processing unit, outputs the packet to the output port of the relevant output port number and when no relevant output port number is searched out, transfers the packet to the middle path unit, the middle path unit includes an exceptional packet determination unit which determines whether a packet transferred from the first path unit is a packet to be a target of exception processing or not and when the packet is a target of the exception processing, transfers the packet to the slow path unit and when the packet is not a target of the exception processing, considers the received packet as a target of routing processing and a routing processing unit which obtains an output port number for the received packet based on a transmission source address and a transmission destination address of the packet considered as a target of the routing processing by the exceptional packet determination unit and the contents of the routing table to output the received packet to an output port of the obtained output port number, and the slow path unit includes an exception processing unit which executes exception processing for a received packet transferred from the middle path unit.

In the packet exchange device of the present invention, the routing processing unit transmits a registration request including obtained transmission source address and transmission destination address of the received packet and output port number to the slow path unit, and the slow path unit includes a flow information registration unit which registers a transmission source address, a transmission destination address and an output port number included in a registration request sent from the middle path unit at the flow cache table.

In the packet exchange device of the present invention, the routing processing unit transmits a registration request including obtained transmission source address, transmission destination address of the received packet and output port number to the first path unit, and the first path unit includes a flow information registration unit which registers, at the flow cache table, a transmission source address, a transmission destination address and an output port number included in a registration request sent from the middle path unit.

A packet exchange method in the packet exchange device according to the present invention used in a packet communication network to execute routing processing on a packet basis, thereby transferring a packet, which is characterized in that the first path unit of the packet exchange device outputs the packet to an output port of an output port number corresponding to a transmission source address and a transmission destination address of a received packet which is registered in the flow cache table, the first path unit of the packet exchange device executes routing processing of determining an output port number for the packet, the first path unit of the packet exchange device executes exception processing for the packet and when the output port number is not registered in the flow cache table, the first path unit transfers the packet to the middle path unit without outputting the packet to the output port, and the middle path unit, when the packet from the first path unit is not a target of exception processing, executes the routing processing and when the packet is a target of exception processing, transfers the packet to the slow path unit.

In the packet exchange device of the present invention, when at the time of packet reception, information (a transmission source address, a transmission destination address and an output port number) regarding a flow to which the received packet belongs is not registered at the flow cache table, that is, when the received packet is a first packet of the flow and no relevant output port number is searched out from the flow cache table with the transmission source address and the transmission destination address of the received packet as a key, the first path unit transfers the received packet to the middle path unit. On the other hand, when information regarding a flow to which the received packet belongs is registered at the flow cache table, the received packet is output to an output port indicated by an output port number in the information related to the flow.

When a received packet is transferred from the first path unit, the middle path unit determines whether the packet is a packet to be a target of exception processing or not. Then, when it is a packet to be a target of exception processing, the unit transfers the packet to the slow path unit to cause the same to execute exception processing. On the other hand, when the packet is not a packet to be a target of exception processing, the unit obtains an output port number of an output port which outputs the packet based on a transmission source address and a transmission destination address of the packet and the contents of a routing table. Thereafter, the unit outputs the packet to an output port having the output port number.

The flow cache table in the first path unit holds an output port number for a received packet which is obtained by the middle path unit and a transmission source address and a transmission destination address of the received packet so as to correlate with each other. Accordingly, processing at the middle path unit will be hereafter unnecessary for a packet belonging to the same flow as that of the received packet.

As a result, even under the environment where exception processing occurs frequently, packet transfer processing can be executed at a high speed.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing an example of a structure of a packet exchange device according to a first embodiment of the present invention;

FIG. 2 is a diagram showing an example of contents of a flow cache table 13;

FIG. 3 is a flow chart showing an example of processing executed when a first path unit 10 receives a packet;

FIG. 4 is a flow chart showing an example of processing of a middle path unit 20;

FIG. 5 is a flow chart showing an example of processing of a slow path unit 30;

FIG. 6 is a block diagram showing an example of a structure of a packet exchange device according to a second embodiment of the present invention;

FIG. 7 is a flow chart showing an example of processing executed when a first path unit 10a receives a registration request; and

FIG. 8 is a block diagram for use in explaining a conventional packet exchange device.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

### First Embodiment

Next, a first embodiment of the present invention will be described in details with reference to the drawings.

### Structure of First Embodiment

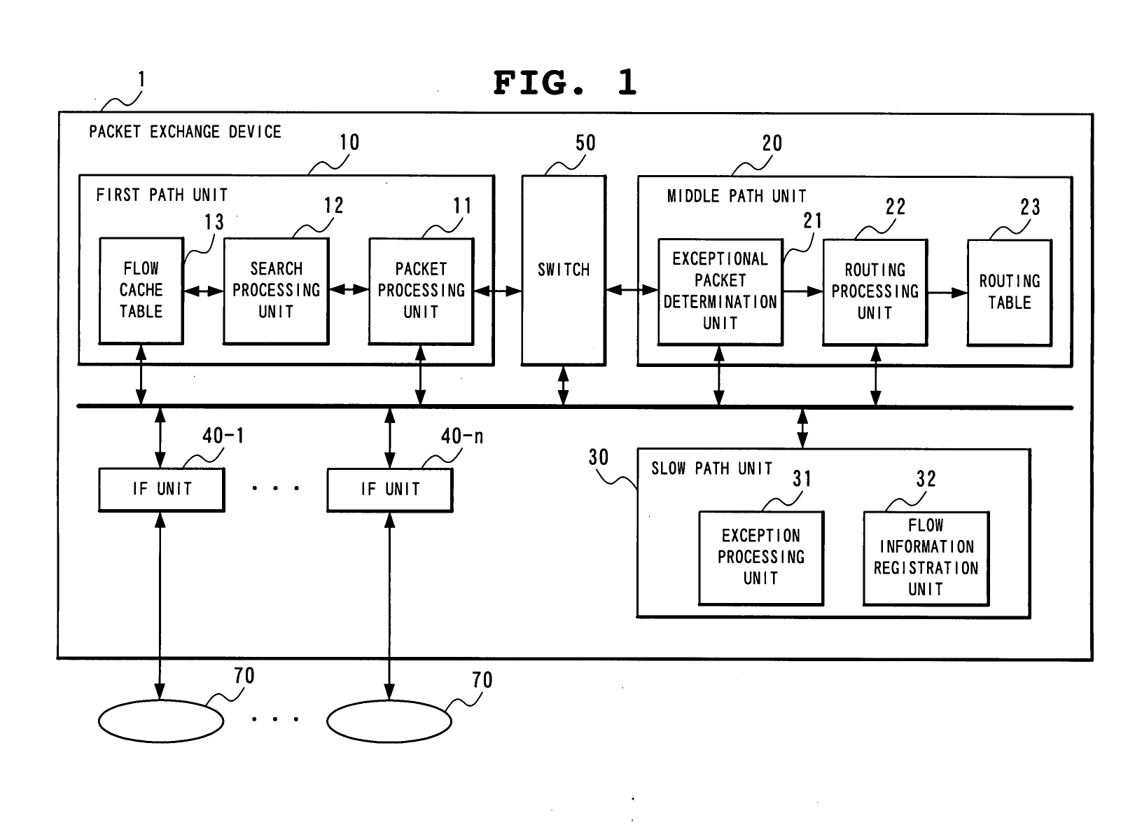

FIG. 1 is a block diagram showing an example of a structure of a packet exchange device 1 according to a first embodiment of the present invention. With reference to the figure, the packet exchange device 1 of the present embodiment includes a first path unit 10, a middle path unit 20, a slow path unit 30, interface units 40-1˜40-n, a switch 50 and a control bus 60 which connects these components.

The interface units 40-1˜40-n have a function of exchanging a packet with a network 70.

The first path unit 10 includes a packet processing unit 11, a search processing unit 12 and a flow cache table 13.

In the flow cache table 13, registered are an output port number and a MAC address of a subsequent hop so as to correlate with a transmission source IP address and a transmission destination IP address as a search key. FIG. 2 shows an example of contents of the flow cache table 13. The example in the figure illustrates that a flow specified by a transmission source IP address “IPs1” and a transmission destination IP address “IPd1” has “P1” as an output port number and “MAC1” as a MAC address of a subsequent hop.

The search processing unit 12 has a function of, when a search request including a transmission source IP address and a transmission destination IP address is transferred from the packet processing unit 11, searching the flow cache table 13 with the transmission source IP address and the transmission destination IP address as a key to return a search result to the packet processing unit 11. When a relevant entry exists on the flow cache table 13, an output port number and a subsequent hop MAC address registered in the entry are returned to the packet processing unit 11 as a search result and when the relevant entry fails to exist on the flow cache table 13, a search failure is returned as a search result.

The packet processing unit 11 has a function of, when receiving a packet through the interface unit 40-k (1≦k≦n), extracting a transmission source IP address and a transmission destination IP address from a header part of the received packet, a function of transferring a search request including extracted transmission source IP address and transmission destination IP address to the search processing unit 12, and a function of, when an output port number and a subsequent hop MAC address are returned from the search processing unit 12 as a search result, after attaching a MAC header to a received packet, outputting the packet to an interface unit specified by the output port number and when a search failure is notified as a search result, transmitting a received packet to the middle path unit 20 through the switch 50.

While the packet processing unit 11 and the search processing unit 12 are preferably realized by hardware for increasing a processing speed, it may be realized by a hardware engine to which programming processing specialized for a CPU or a network is applicable.

In addition, the packet processing unit 11 and the search processing unit 12 of the packet exchange device can be realized as software by executing a program which provides each function of the above-described respective components by the CPU. In other words, the CPU realizes the above-described respective functions as software by loading and executing a program stored in a subsidiary storage unit.

The middle path unit 20 includes an exception packet determination unit 21, a routing processing unit 22 and a routing table 23.

The exception packet determination unit 21 has a function of determining whether a packet transferred from the first path unit 10 is a packet to be a target of exception processing or not and a function of transferring a packet determined to be a target of exception processing to the slow path unit 30 and transferring a packet determined not to be a target of exception processing to the routing processing unit 22. The exception processing includes processing of an IPv4 option packet, processing of an IPv6 expansion header and management of STM.

The routing processing unit 22 has the following functions.

(1) The function of extracting a transmission source IP address and a transmission destination IP address from a header part of a packet transferred from the exception packet determination unit 21.

(2) The function of obtaining an output port number and a subsequent hop MAC address of the packet based on each of the extracted addresses and the contents of the routing table 23.

(3) The function of attaching a MAC header to a packet to output the packet to an interface unit corresponding to an extracted output port number.

(4) The function of transmitting, to the slow path unit 30, a registration request including a transmission source IP address and a transmission destination IP address of a packet and an output port number and a subsequent hop MAC address obtained by using the routing table 23.

While the exception packet determination unit 21 and the routing processing unit 22 are preferably realized by hardware for enabling high-speed processing, it may be realized by a hardware engine to which programming processing specialized for a CPU or a network is applicable. In addition, by executing a program which provides each of these functions by the CPU, these units can be realized as software.

The slow path unit 30, which is realized by the CPU, includes an exception processing unit 31 and a flow information registration unit 32.

The exception processing unit 31 has a function of executing exception processing for a packet transferred from the middle path unit 20.

The flow information registration unit 32 has a function of registering an output port number and a subsequent hop MAC address so as to correlate with a transmission source IP address and a transmission destination IP address at a free entry of the flow cache table 13 according to a registration request sent from the middle path unit 20.

### Operation of the First Embodiment

Next, operation of the first embodiment will be detailed.

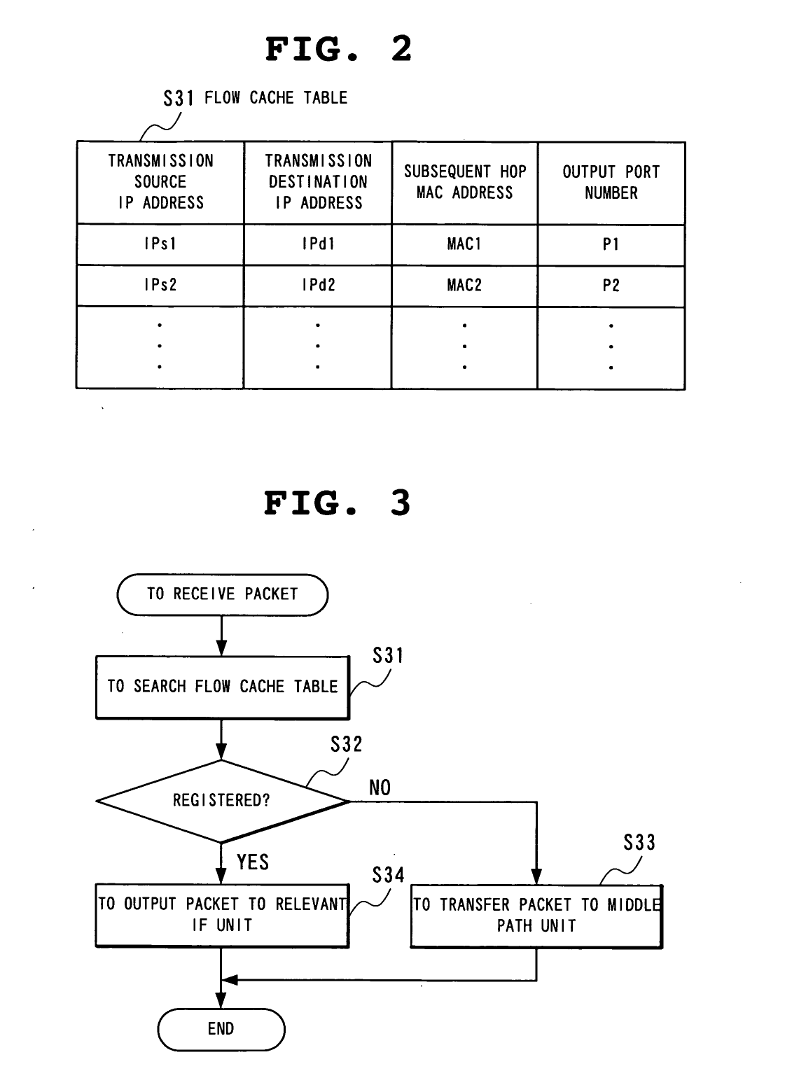

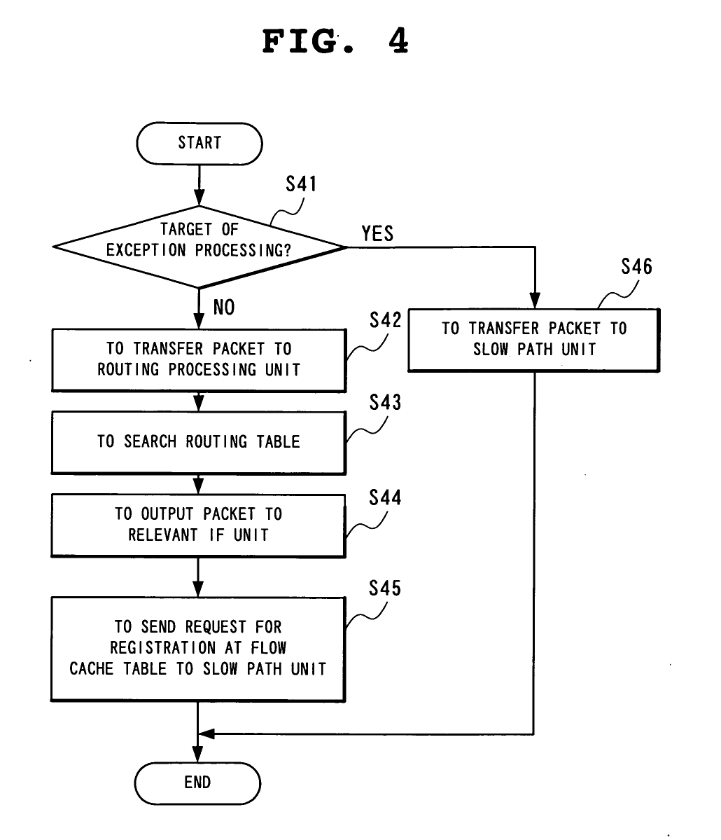

First, operation of the first path unit 10 will be described with reference to the flow chart shown in FIG. 3.

Upon receiving a packet through the interface unit 40-k, the packet processing unit 11 in the first path unit 10 extracts a transmission source IP address and a transmission destination IP address from a header part of the packet to transfer a search request including these addresses to the search processing unit 12 (Step S31 in FIG. 3). As a result, the search processing unit 12 searches the flow cache table 13 with the transmission source IP address and the transmission destination IP address in the search request as a key.

Then, when there exists a relevant entry on the flow cache table 13, return an output port number and a subsequent hop MAC address registered in the entry as a search result and when there exists no relevant entry, return a search failure as a search result. Assume, for example, that the contents of the flow cache table 13 are as shown in FIG. 2 and the transmission source IP address and the transmission destination IP address in the search request are IPs2 and IPd2, respectively, the search processing unit 12 will return the subsequent hop MAC address “MAC2” and the output port number “P2” as a search result to the packet processing unit 11.

When the search failure is returned from the search processing unit 12 as a search result, that is, when a received packet is a first packet in a flow to which the packet belongs and information of the relevant flow is not registered in the flow cache table 13 (No at Step 32), the packet processing unit 11 transfers the received packet to the middle path unit 20 through the switch 50 (Step S33).

On the other hand, when an output port number and a subsequent hop MAC address are returned from the search processing unit 12 as a search result (Yes at Step S32), the packet processing unit attaches a MAC header including the subsequent hop MAC address to the received packet and then outputs the packet with the MAC header attached to the interface unit specified by the output port number (Step S34).

Operation of the middle path unit 20 will be described with reference to the flow chart shown in FIG. 4.

When a packet is sent from the first path unit 10 through the switch 50, the exception packet determination unit 21 in the middle path unit 20 determines whether the packet is a target of exception processing or not based on the contents of its header part (Step S41 in FIG. 4).

Then, when determining that the received packet is not a packet to be a target of exception processing (No at Step S41), the unit transfers the packet to the routing processing unit 22 (Step S42). As a result, the routing processing unit 22 searches the routing table 23 with a transmission destination IP address of the packet as a key to execute routing processing of obtaining an output port number and a subsequent hop MAC address (Step S43).

Thereafter, the routing processing unit 22 attaches a MAC header including the MAC address to the packet to output the packet to the interface unit specified by the output port number (Step S44).

Moreover, the routing processing unit 22 transmits a registration request including the transmission source IP address and the transmission destination IP address of the packet and the output port number and the subsequent hop MAC address searched from the routing table 23 to the slow path unit 30 (Step S45).

On the other hand, when determining that the packet is a target of exception processing at Step S41, transmit the packet to the slow path unit 30 (Step S46).

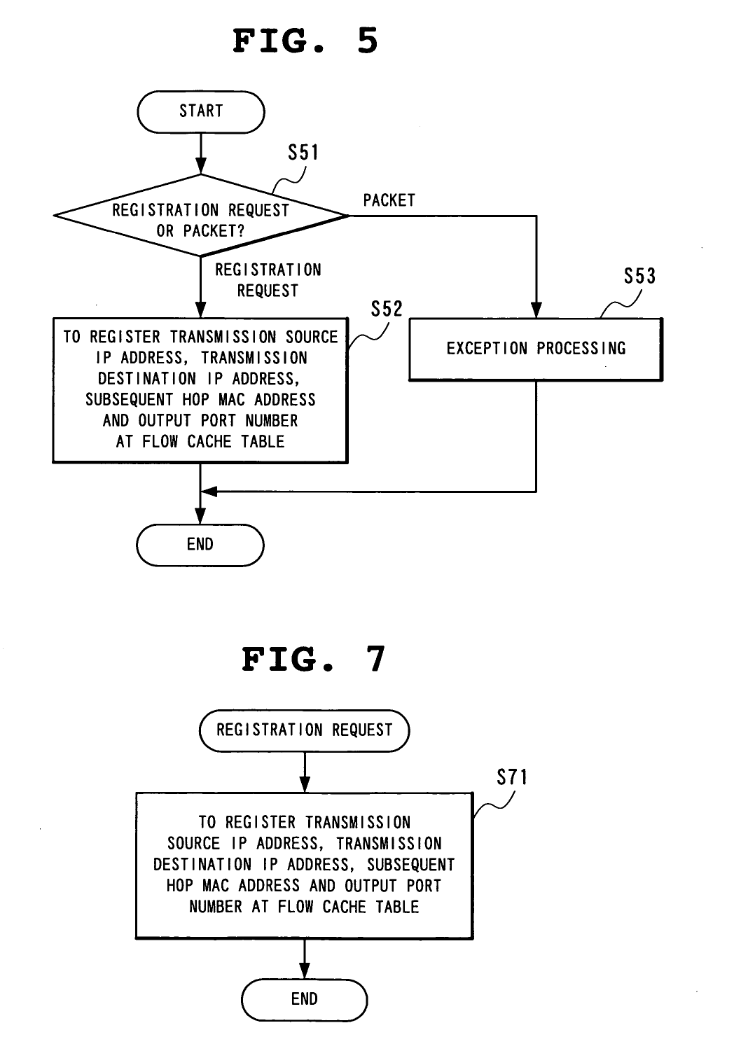

Operation of the slow path unit 30 will be described with reference to the flow chart shown in FIG. 5.

When the registration request is sent from the middle path unit 20, the slow path unit 30 uses the flow information registration unit 32 to register the transmission source IP address, the transmission destination IP address, the subsequent hop MAC address and the output port number included in the registration request at a free entry (Steps S51 and S52 in FIG. 5).

When a packet is sent from the middle path unit 20, execute exception processing by using the exception processing unit 31 (Steps S51 and S53).

### Effect of First Embodiment

According to the present embodiment, even under the environment where exception processing occurs frequently, packet transfer processing can be executed at a high speed. The reason is that in addition to the first path unit 10 and the slow path unit 30, the middle path unit 20 is provided to execute routing processing using a routing table which had been conventionally executed by the slow path unit 30. In other words, the middle path unit 20 and the slow path unit 30 need to execute only the routing processing and the exception processing, respectively, so that even under the environment where exception processing occurs frequently, the routing processing can be executed at a high speed by the middle path unit 20.

### Second Embodiment

Next, a second embodiment of the present invention will be described. The present embodiment is characterized in that processing of registration at the flow cache table 13 is executed by the first path unit 10.

### Structure of Second Embodiment

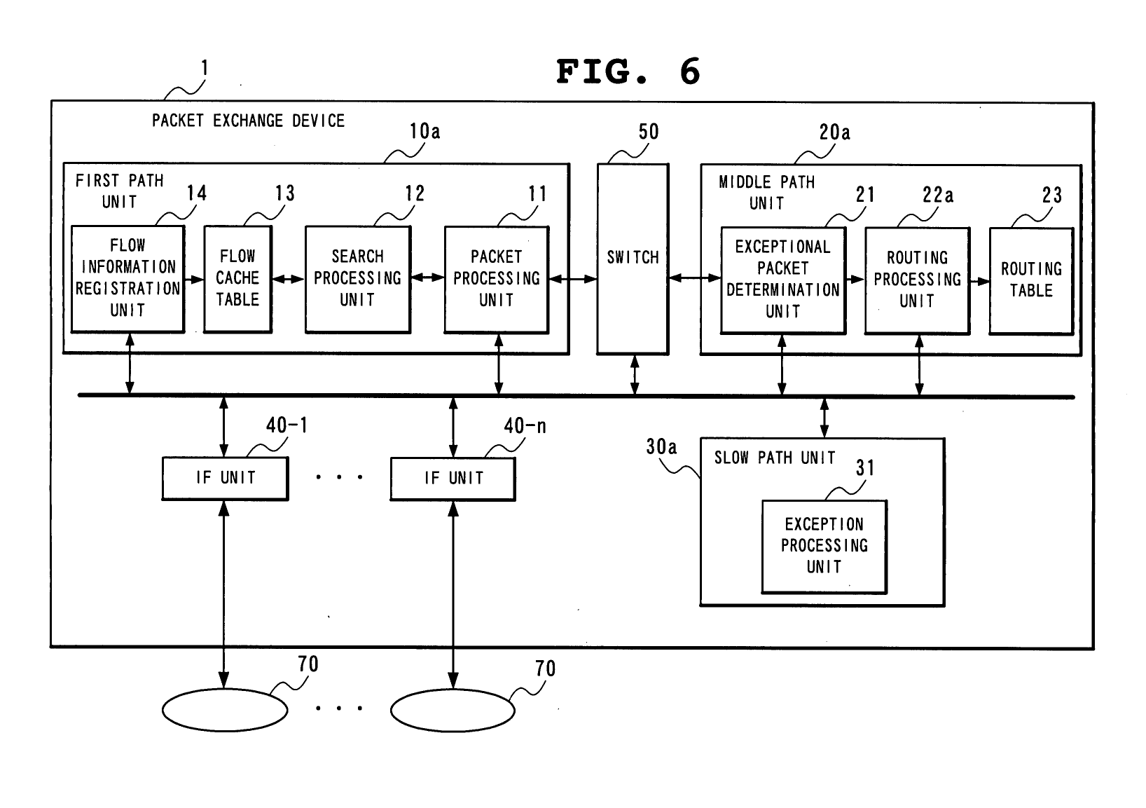

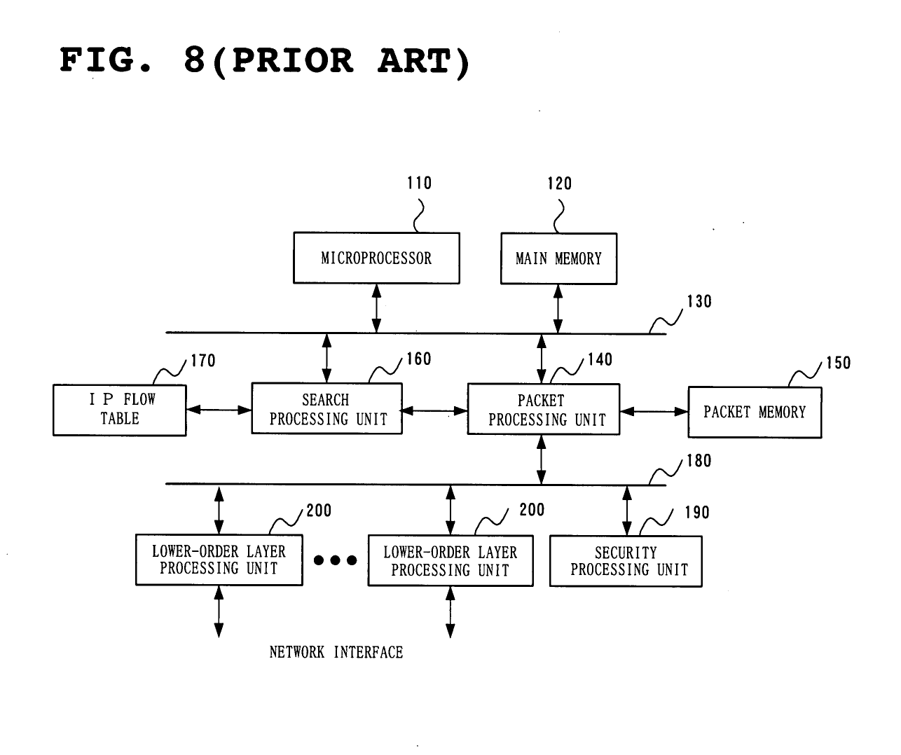

FIG. 6 is a block diagram showing an example of a structure of a packet exchange device 1a according to the second embodiment of the present invention. The packet exchange device 1a of the present embodiment differs from the packet exchange device 1 shown in FIG. 1 in having a first path unit 10a in place of the first path unit 10, a middle path unit 20a in place of the middle path unit 20 and a slow path unit 30a in place of the slow path unit 30.

The first path unit 10a differs from the first path unit 10 in that a flow information registration unit 14 realized by a CPU or the like is added. The flow information registration unit 14 has a function of registering a transmission source IP address, a transmission destination IP address, a subsequent hop MAC address and an output port number at the flow cache table 13 according to a registration request sent from the middle path unit 20a.

The middle path unit 20a differs from the middle path unit 20 in having a routing processing unit 22a in place of the routing processing unit 22.

The routing processing unit 22a differs from the routing processing unit 22 in that the routing processing unit 22a transmits a registration request to the first path unit 10a, while the routing processing unit 22 transmits a registration request to the slow path unit 30.

The slow path unit 30a differs from the slow path unit 30 in failing to have the flow information registration unit 32.

### Operation of Second Embodiment

Next, operation of the present embodiment will be described.

Upon receiving a packet through an interface unit 40-k, the first path unit 10a executes the above-described processing shown in the flow chart of FIG. 3 to transfer the packet to the middle path unit 20a when the packet is a first packet in the flow (No at Steps S31 and S32: S33) and outputs the packet to the interface unit having an output port corresponding to its transmission destination when the packet is not a first packet (Yes at Steps S31 and S32: S34).

When the packet is sent from the first path unit 10a through the switch 50, the middle path unit 20a executes substantially the same processing as that described above with respect to the flow chart shown in FIG. 4.

In the present embodiment, in place of the processing of Step S45 (request for registration at the slow path unit), processing of transmitting a request for registration at the flow cache table 13 to the first path unit 10a is executed.

More specifically, in the present embodiment, the routing processing unit 22a transmits, to the first path unit 10a through the control bus 60, a registration request including a transmission source IP address and a transmission destination IP address of the packet sent from the first path unit 10a and a subsequent hop MAC address and an output port number obtained by searching the routing table 23 at Step S43.

Operation executed by the first path unit 10a upon receiving a registration request is shown in FIG. 7.

When a registration request is sent from the middle path unit 20a, the first path unit 10a registers a transmission source IP address, a transmission destination IP address, a subsequent hop MAC address and an output port number included in the registration request at a free entry on the flow cache table 13 by using the flow information registration unit 14 (Step S71 in FIG. 7).

While in the present embodiment, the routing processing unit 22a transmits a registration request to the first path unit 10a and the flow information registration unit 14 in the first path unit 10a registers a transmission source IP address, a transmission destination IP address, a subsequent hop MAC address and an output port number included in the registration request at the flow cache table 13, the routing processing unit 22a may directly register each of the above-described information at the flow cache table 13 through a control bus 60. In such a case, the flow information registration unit 14 in the first path unit 10a will be unnecessary.

### Effect of Second Embodiment

According to the present embodiment, in addition to the effect produced by the first embodiment, load on the slow path unit 30a can be reduced. The reason is that with the flow information registration unit 14 provided in the first path unit 10a, processing of registration at the flow cache table 13 which is executed by the slow path unit 30 in the first embodiment is executed by the first path unit 10a.

Even under the environment where exception processing occurs frequently, the present invention enables packet transfer processing to be executed at a high speed. The reason is that in addition to the first path unit and the slow path unit, the middle path unit is provided to execute routing processing using a routing table which had been conventionally executed by a slow path unit. In other words, the middle path unit and the slow path unit need to execute only the routing processing and the exception processing, respectively, so that even under the environment where exception processing occurs frequently, the routing processing can be executed at a high speed by the middle path unit.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A packet exchange device used for a packet communication network to execute routing processing on a packet basis and transfer a packet, comprising:
a first path unit which outputs, to an output port having an output port number which is registered at a flow cache table and corresponds to a transmission source address and a transmission destination address of a received packet, said packet;
a middle path unit which executes routing processing of determining an output port number for said packet; and
a slow path unit which executes exception processing for said packet; wherein
when said output port number is not registered at said flow cache table, said first path unit transfers said packet to said middle path unit without outputting said packet to said output port, and
when said packet from said first path unit is not a target of exception processing, said middle path unit executes said routing processing and when said packet is a target of exception processing, transfers said packet to said slow path unit.

2. The packet exchange device as set forth in claim 1, wherein
at said flow cache table, an output port number for said packet obtained by said routing processing by said middle path unit and a transmission source address and a transmission destination address of said packet are registered so as to correlate with each other.

3. The packet exchange device as set forth in claim 1, wherein
said first path unit includes
a search processing unit which searches said flow cache table with a transmission source address and a transmission destination address of said packet as a key, and
a packet processing unit which outputs, when an output port number of an output port which outputs said packet is searched out by said search processing unit, said packet to an output port having the output port number and when the output port number is not searched out, transfers said packet to said middle path unit,
said middle path unit includes
an exceptional packet determination unit which determines whether said packet transferred from said first path unit is a packet to be a target of exception processing and when said packet is a target of exception processing, transfers said packet to said slow path unit and when said packet is not a target of exception processing, considers said received packet as a target of routing processing, and
a routing processing unit which obtains an output port number for said received packet based on a transmission source address and a transmission destination address of said packet considered as a target of said routing processing by said exceptional packet determination unit and the contents of a routing table to output said received packet to an output port having the obtained output port number, and
said slow path unit includes
an exception processing unit which executes exception processing for a received packet transferred from said middle path unit.

4. The packet exchange device as set forth in claim 3, wherein
said routing processing unit transmits a registration request including obtained transmission source address and transmission destination address of said received packet and said output port number to said slow path unit, and
said slow path unit includes a flow information registration unit which registers a transmission source address, a transmission destination address and an output port number included in a registration request sent from said middle path unit at said flow cache table.

5. The packet exchange device as set forth in claim 3, wherein
said routing processing unit transmits a registration request including obtained transmission source address and transmission destination address of said received packet and said output port number to said first path unit, and
said first path unit includes a flow information registration unit which registers a transmission source address, a transmission destination address and an output port number included in a registration request sent from said middle path unit at said flow cache table.

6. The packet exchange device as set forth in claim 3, wherein
said routing processing unit registers an output port number searched from said routing table at said flow cache table so as to correlate with a transmission source address and a transmission destination address of said received packet.

7. A packet exchange method at a packet exchange device which executes routing processing on a packet basis to transfer a packet in a packet communication network, wherein
a first path unit of said packet exchange device outputs, to an output port having an output port number which is registered at a flow cache table and corresponds to a transmission source address and a transmission destination address of a received packet, said packet,
said first path unit of said packet exchange device executes routing processing of determining an output port number for said packet, and
said first path unit of said packet exchange device executes exception processing for said packet, and wherein
when said output port number is not registered at said flow cache table, said first path unit transfers said packet to said middle path unit without outputting said packet to said output port, and
when said packet from said first path unit is not a target of exception processing, said middle path unit executes said routing processing and when said packet is a target of exception processing, transfers said packet to said slow path unit.

8. The packet exchange method as set forth in claim 7, wherein
at said flow cache table, an output port number for said packet obtained by said routing processing by said middle path unit and a transmission source address and a transmission destination address of said packet are registered so as to correlate with each other.

9. The packet exchange method as set forth in claim 7, wherein
said first path unit
searches said flow cache table with a transmission source address and a transmission destination address of said packet as a key, and
when an output port number of an output port which outputs said packet is searched out, outputs said packet to an output port having the output port number and when the output port number is not searched out, transfers said packet to said middle path unit,
said middle path unit
determines whether said packet transferred from said first path unit is a packet to be a target of exception processing and when said packet is a target of exception processing, transfers said packet to said slow path unit and when said packet is not a target of exception processing, considers said received packet as a target of routing processing, and
obtains an output port number for said received packet based on a transmission source address and a transmission destination address of said packet considered as a target of said routing processing and the contents of a routing table to output said received packet to an output port having the obtained output port number, and
said slow path unit executes exception processing for a received packet transferred from said middle path unit.

10. The packet exchange method as set forth in claim 9, wherein
said middle path unit transmits a registration request including obtained transmission source address and transmission destination address of said received packet and said output port number to said slow path unit, and
said slow path unit registers a transmission source address, a transmission destination address and an output port number included in a registration request sent from said middle path unit at said flow cache table.

11. The packet exchange method as set forth in claim 9, wherein
said middle path unit transmits a registration request including obtained transmission source address and transmission destination address of said received packet and said output port number to said first path unit, and
said first path unit registers a transmission source address, a transmission destination address and an output port number included in a registration request sent from said middle path unit at said flow cache table.

12. The packet exchange method as set forth in claim 9, wherein
said middle path unit registers an output port number searched from said routing table at said flow cache table so as to correlate with a transmission source address and a transmission destination address of said received packet.

13. A program executed on a packet exchange device which executes routing processing on a packet basis to transfer a packet in a packet communication network, comprising the functions of:
a function of a first path unit of said packet exchange device to output, to an output port having an output port number which is registered at a flow cache table and corresponds to a transmission source address and a transmission destination address of a received packet, said packet,
a function of said first path unit of said packet exchange device to execute routing processing of determining an output port number for said packet, and
a function of said first path unit of said packet exchange device to execute exception processing for said packet, wherein
when said output port number is not registered at said flow cache table, said first path unit executes said function of transferring said packet to said middle path unit without outputting said packet to said output port, and
when said packet from said first path unit is not a target of exception processing, said middle path unit executes said routing processing and when said packet is a target of exception processing, executes said function of transferring said packet to said slow path unit.

14. The program according to claim 13, which executes said function of registering, at said flow cache table, an output port number for said packet obtained by said routing processing by said middle path unit and a transmission source address and a transmission destination address of said packet so as to correlate with each other.

15. The program as set forth in claim 13, wherein
said first path unit executes
said function of searching said flow cache table with a transmission source address and a transmission destination address of said packet as a key, and
said function of, when an output port number of an output port which outputs said packet is searched out, outputting said packet to an output port having the output port number and when the output port number is not searched out, transferring said packet to said middle path unit,
said middle path unit executes
said function of determining whether said packet transferred from said first path unit is a packet to be a target of exception processing and when said packet is a target of exception processing, transferring said packet to said slow path unit and when said packet is not a target of exception processing, considering said received packet as a target of routing processing, and
said function of obtaining an output port number for said received packet based on a transmission source address and a transmission destination address of said packet considered as a target of said routing processing and the contents of a routing table to output said received packet to an output port having the obtained output port number, and
said slow path unit executes
said function of executing exception processing for a received packet transferred from said middle path unit.

16. The program as set forth in claim 15, wherein
said middle path unit executes said function of transmitting a registration request including obtained transmission source address and transmission destination address of said received packet and said output port number to said slow path unit, and
said slow path unit executes said function of registering a transmission source address, a transmission destination address and an output port number included in a registration request sent from said middle path unit at said flow cache table.

17. The program as set forth in claim 15, wherein
said middle path unit executes said function of transmitting a registration request including obtained transmission source address and transmission destination address of said received packet and said output port number to said first path unit, and
said first path unit executes said function of registering a transmission source address, a transmission destination address and an output port number included in a registration request sent from said middle path unit at said flow cache table.

18. The program as set forth in claim 15, wherein
said middle path unit executes said function of registering an output port number searched from said routing table at said flow cache table so as to correlate with a transmission source address and a transmission destination address of said received packet.
